(19) United States
(12) Patent Application Publication
(10) Pub. No.: US 2016/0233664 A1
(43) Pub. Date: Aug. 11, 2016

(54) AUTOMATIC WIRING BOARD

(71) Applicant: GRACO MINNESOTA INC., Minneapolis, MN (US)

(72) Inventors: Mark J. Brudevold, Fridley, MN (US); Robert A. Prigge, St. Paul Park, MN (US); Benjamin R. Godding, St. Cloud, MN (US)

(21) Appl. No.: 15/029,924

(22) PCT Filed: Nov. 13, 2014
(86) PCT No.: PCT/US14/65364

§ 371 Date: Apr. 15, 2016

Related U.S. Application Data
(60) Provisional application No. 61/903,633, filed on Nov. 13, 2013.

(51) Int. Cl. H02H 7/10; H02H 3/24; H02J 4/00; H02H 3/20

(52) U.S. Cl. CPC H02H 7/10; H02H 3/20; H02H 3/24; H02J 4/00

(57) ABSTRACT

A power distribution system for supplying AC power to loads includes an automatic wiring board that realigns voltages and determines a user-supplied wiring configuration. If an acceptable configuration is detected, an auto-wiring relay circuit closes relays to provide appropriate connections from a terminal block to power controllers that control delivery of AC power to loads, such as heating elements. If wiring configuration is incorrect or voltage is outside a safe voltage range, the auto-wiring relay circuit remains open to protect the controllers and loads.

### CROSS-REFERENCE TO RELATED APPLICATION(S)

This application is a non-provisional of US Application Serial No. 61/903,633, filed on Nov. 13, 2013.

### BACKGROUND

The present disclosure relates generally to systems for dispensing hot melt adhesive. More particularly, the present disclosure relates to providing electrical power to heaters of a hot melt dispensing system.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank or melter, the pump and the dispenser, as well as heating any tubing or hoses that connect those components.

The heating elements of a hot melt system may be operated using alternating current (AC) power. Temperature controllers can be used to connect and disconnect electrical loads to AC input power such as a heating element in order to heat the hot melt adhesive to a temperature of about 350° F. The controllers can make use of a switch, such as a relay or a solid state switch connected between the source of input power and the load. A processor within the controller controls the operation of the switch to connect the load to input power when the load is to be operated and to disconnect the load under certain conditions, such as when the desired temperature has been exceeded. The available AC input power for operating heating elements of a hot melt system may be single-phase AC power, three-phase 230 volt AC power or three-phase 400 volt AC power and may be supplied by a two, three, or four wire electrical service.

### SUMMARY

A system for supplying AC power to loads includes a terminal block, a voltage sensing circuit, an auto-wiring relay circuit, and a digital processor. The terminal block includes a plurality of terminals for connection to input AC power. The voltage sensing circuit senses AC voltage between the terminals of the terminal block. A plurality of controllers provides AC power to loads. The auto-wiring relay circuit selectively connects terminals of the terminal block to the plurality of controllers. The digital processor controls the auto-wiring relay circuit based upon the sensed AC voltages.

### BRIEF DESCRIPTION OF THE DRAWINGS

FIG. 1 is an electrical block diagram of a system for providing AC power to selected heating elements of a hot melt dispensing system.

### DETAILED DESCRIPTION

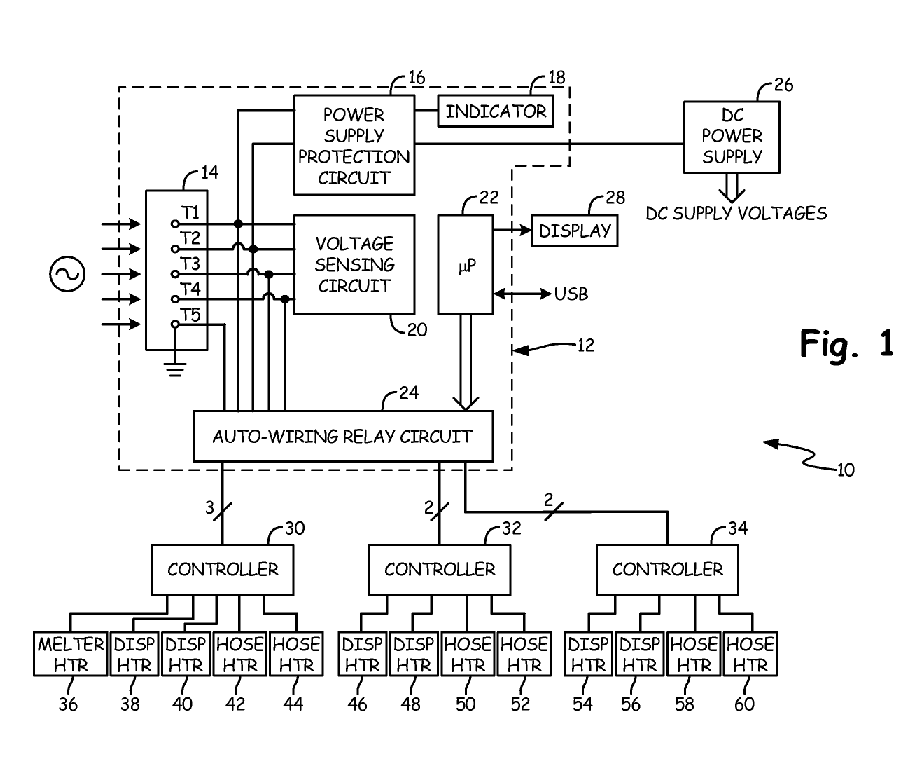

FIG. 1 is an electrical block diagram of electrical power distribution system 10 of a hot melt dispensing system. System 10 includes automatic wiring board 12 (which includes terminal block 14, power supply protection circuit 16, indicator 18, voltage sensing circuit 20, microprocessor 22, and auto-wiring circuit relay circuit 24), DC power supply 26, display 28, and controllers 30, 32, and 34. Controller 30 controls AC power to melter heater 36, dispenser heaters 38 and 40, and hose heaters 42 and 44. Power controller 32 controls AC power to dispenser heaters 46 and 48 and hose heaters 50 and 52. Controller 34 controls AC power supply to dispenser heaters 54 and 56 and hose heaters 58 and 60.

Input AC power to automatic wiring board 12 to be supplied on two, three, or four wires which are connected to terminals T1-T4 of terminal block 14. Connection to earth ground is provided at terminal T5 of terminal block 14.

When single-phase AC power is supplied to automatic wiring board 12, wires carrying the two-phase AC should be connected to terminals T1 and T2 of terminal block 14. When three-phase 240 volt AC power is supplied, wires connecting the three-phases should be connected to terminals T1, T2, and T3. When three-phase 400 volt AC power is supplied, the wires for the three-phases should be connected to T1-T3, and neutral line should be connected to terminal T4.

Power supply protection circuit 16 is connected to terminals T1 and T2. It receives single-phase AC power from terminals T1 and T2. Power supply protection circuit 16 supplies protected power to DC power supply 26. In the event of an over voltage condition, power supply protection circuit 16 protects DC power supply from damage due to high voltages. Power supply protection circuit 16 allows DC power supply to operate even during an over-voltage condition. Indicator 18 provides an indication of whether an over-voltage or an under voltage condition is present.

DC power supply 26 provides DC supply voltages to the circuitry control system 10. These supply voltages are provided to voltage sensing circuit 20, microprocessor 22, auto-wiring relay circuit 24, display 28, and power controllers 30, 32, and 34.

Voltage sensing circuit 20 and microprocessor 22 monitor line voltages to identify whether single-phase or three-phase power is being supplied and whether 400 volt power is present. Voltage sensing circuit 20 is connected to each of terminals T1-T4. It provides an input to microprocessor 22 of the voltage between each combination of two terminals. Based upon the inputs from voltage sensing circuit 20, microprocessor 22 identifies whether power is single-phase or three-phase, and whether the three-phase voltage is 400 volt power. It also determines whether the user has connected the input power wires to terminals T1-T4 in the expected configuration, or in a different configuration than expected. Based upon this determination, microprocessor 22 provides control signals to auto-wiring relay circuit 24. If voltage is too high, microprocessor 22 will not allow auto-wiring relay circuit 24 to connect power to any power controllers 30, 32, and 34. If voltage is too high, indicator 18, which may be a red light emitting diode, will also turn on. If input voltage is too low, microprocessor 22 will not allow auto-wiring relay circuit 24 to connect controllers 30, 32, and 34 to terminal block 14, and will cause display 28 to display an error code.

If microprocessor 22 determines that the supplied AC power is single-phase, and the voltage is within a normal range, it will provide control signals to auto-wiring relay circuit 24 to connect each controller 30, 32, and 34 to the same two terminals at which the single-phase AC power is present. Normally this will be terminals T1 and T2.

If microprocessor 22 determines that voltage is within an acceptable range and 400 volt three-phase AC power is present, microprocessor 22 will provide control signals to auto-wiring relay circuit 24 to selectively connect controllers 30, 32, and 34 to terminal block 14. Three wires are provided to controller 30 from auto-wiring relay circuit 24. Assuming that T1-T3 receive the three-phases and T4 is neutral, auto-wiring relay circuit 24 connects the three wires to terminal T1, terminal T2, and terminal T4 (the neutral line). Controller 30 uses one phase of AC power to provide power to melter heater 36. The other phase of AC power is used to power dispenser heaters 38 and 40 and hose heaters 42 and 44.

Two wires are provided from auto-wiring relay circuit 24 to controller 32. Auto-wiring relay circuit uses these two wires to connect controller 32 to terminals T3 and T4. The single-phase power received by controller 32 is used to energize dispenser heaters 46 and 48 and hose heaters 50 and 52.

Two wires are provided from auto-wiring relay circuit 24 to controller 34. Auto-wiring relay circuit uses the two wires to connect terminals T1 and T4 through auto-wiring relay circuit 24 to power controller 34. The single phase AC power is used by power controller 34 to energize dispenser heaters 54 and 56 and hose heaters 58 and 60.

In the case of 230 volt three-phase AC power with no neutral wire, microprocessor 22 controls auto-wiring relay circuit in a similar manner, except that earth ground at terminal T5 is used rather than a neutral wire at terminal T4.

In other words, microprocessor 22, in conjunction with voltage sensing circuit 20, reads the line voltages and determines the user supply of wiring configuration. If an acceptable configuration is detected, microprocessor 22 causes the appropriate relays within auto-wiring relay circuit 24 to close, so that controllers 30, 32, and 34 are connected to the terminals that will supply the AC input power to the heaters. If the wiring is incorrect or if voltages are outside of a safe voltage range, microprocessor 22 causes the relays of auto-wiring relay circuit 24 to remain open. This protects the electronics of controllers 30, 32, and 34 and the heaters that they are connected to from damage due to unsafe voltages.

Microprocessor 22 includes associated memory, such as flash memory, in order to log and track the wiring configuration detected and the measured voltages. This data can be made available for troubleshooting, such as through a USB data download.

Amperage allowed to each power controller 30, 32, and 34 is calculated by microprocessor 22 and is divided up based upon the voltage configuration and the amperage setting on display screen 28. The user can select a permitted amperage, and the voltage distribution needed is automatically determined by microprocessor 22 in conjunction with auto-wiring relay circuit 24.

Control system 10, and in particular automatic wiring board 12 provides a number of advantages. First, end user electrical insulation is reduced and simplified through simple connection of the power wires to the auto-wiring relay circuit 24. Second, over voltage and mis-wiring protection is provided. Third, display 28 still powers up and shows an error when a mis-wired or over-voltage condition is present. Fourth, over voltage diagnostics are provided through data storage by microprocessor 22. Fifth, the use of configurable jumpers for accommodating different AC input configurations is eliminated, because microprocessor 22 can detect the actual wiring configuration and control auto-wiring relay circuit 24 appropriately. Sixth, the use of preconfigured jumpers and the need for part numbers for those jumpers is eliminated. Seventh, customer voltage and wiring configurations are logged by microprocessor 22 and can be used for troubleshooting.

While the invention has been described with reference to an exemplary embodiment(s), it will be understood by those skilled in the art that various changes may be made and equivalents may be substituted for elements thereof without departing from the scope of the invention. For example, although the specific example described involves controllers supplying power to heating elements, in other embodiments other types of electrical loads can be supplied power. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
a terminal block that includes a plurality of terminals for connection to input AC power;
a voltage sensing circuit for sensing AC voltages between the terminals;
a plurality of controllers for providing AC power to loads;
an auto-wiring relay circuit for selectively connecting terminals of the terminal block to the plurality of controllers; and
a digital processor for controlling the auto-wiring relay circuit based upon the sensed AC voltages between the terminals.

2. The system of claim 1 and further comprising:
a power supply for deriving DC power from the input AC power and supplying the DC power to the voltage sensing circuit, the controllers , the auto-wiring relay circuit, and the digital processor, and
a power supply protection circuit connected between the terminal block and the power supply.

3. The system of claim 1, wherein the digital processor determines a wiring configuration for the plurality of terminals based upon the sensed AC voltages.

4. The system of claim 3, wherein the digital processor provides control signals to the auto-wiring relay circuit to selectively connect the controllers to the plurality of terminals based on the wiring configuration.

5. The system of claim 4, wherein the digital processor prevents the auto-wiring relay circuit from connecting the controllers to the plurality of terminals if the sensed voltages indicate an over-voltage condition.

6. The system of claim 4, wherein the digital processor prevents the auto-wiring relay circuit from connecting the controllers to the plurality of terminals if the sensed voltages indicate a low voltage condition.

7. The system of claim 1, wherein the controllers are temperature controllers and the loads are heating elements.

8. A method of controlling supply of input AC power to a load, the method comprising:
sensing voltages of the input AC power at a plurality of input terminals;
controlling connection of the input AC power to a plurality of controllers as a function of the voltages sensed; and
supplying the input AC power from each of the controllers to load associated with that controller.

9. The method of claim 8 and further comprising:
determining a wiring configuration for the plurality of input terminals based on sensed voltages between the terminals.

10. The method of claim 9 and further comprising:
selectively connecting terminals to the controllers based on the wiring configuration and phase and voltage of the input AC power.

11. The method of claim 8 and further comprising:
preventing connection of the terminals and the controllers if an over-voltage condition is indicated by the voltages sensed.

12. The method of claim 11 and further comprising:
preventing connection of the terminals and the controllers if a low voltage condition is indicated by the voltages sensed.

13. The method of claim 8, wherein the controllers are temperature controllers and the loads are heating elements.
